(19) United States
(12) Patent Application Publication
(10) Pub. No.: US 2017/0343670 A1
(43) Pub. Date: Nov. 30, 2017

(54) LOW POWER LIDAR SYSTEM

(71) Applicant: Grant Matthews, Fort Wayne, IN (US)

(72) Inventor: Grant Matthews, Fort Wayne, IN (US)

(21) Appl. No.: 15/676,090

(22) Filed: Aug. 14, 2017

Related U.S. Application Data
(63) Continuation-in-part of application No. 14/828,705, filed on Aug. 18, 2015.

(51) Int. Cl. G01S 17/10; G01S 7/497; G01S 17/32; G01S 17/93

(52) U.S. Cl. CPC G01S 17/10; G01S 17/936; G01S 7/497; G01S 17/32

(57) ABSTRACT

A vehicle with a LIDAR system, the LIDAR system having an emitter, receivers and a controller. The emitter emitting a Fourier series sum signal with each frequency given a substantially randomized phase. The receivers include a first receiver receiving a portion of the signal proximate to the LIDAR system; and a second receiver receiving a portion of a reflected signal, the reflected signal being a portion of the series sum signal after being reflected off of an object. The controller is coupled to the emitter and the receivers. The controller being configured to de-convolve the portion of the reflected signal received by the second receiver with the portion of the series sum signal received by the first receiver, and to estimate a distance to the object dependent upon an identified time delay between the portion of the reflected signal and the portion of the series sum signal.

### CROSS REFERENCE TO RELATED APPLICATIONS

This is a continuation-in-part of U.S. patent application Ser. No. 14/828,705, entitled “Fourier Domain LOCKIN Imaging for high accuracy and low signal Continuous Wave Sounding”, filed Aug. 18, 2015, which is incorporated herein by reference.

### FIELD OF THE INVENTION

The present invention relates to the field sounding a medium using a continuous wave signal for example of light or sound. More specifically, the present invention relates to using a digital form of a LOCKIN amplifier to image the medium at any desired level of accuracy for a minimal amount of power, limited only by the bandwidth theorem. A use of the present invention with vehicles is disclosed herein.

### BACKGROUND OF THE INVENTION

The process of active sounding is used in fields such as seismic imaging and LIDAR probing of Earth's atmosphere. These techniques involve transmitting a wave 4 S(t), typically made of sound or light, and receiving the returned signal reflected from the medium 7 to be sounded (see FIG. 1)

### OBJECTS OF THE INVENTION

It is an initial objective of this invention to use a continuous wave sounding signal that enables high quality imaging of a medium 7 with low power requirements in a system displayed by FIG. 1. This must operate without the need to use a pulse wave, thereby requiring far lower energy requirements in the transducer used. The technique is applicable to seismic and LIDAR sounding systems.

Still further, other objects and advantages of the invention with respect to high quality sounding of a medium will be apparent from the specification and drawings.

### SUMMARY OF THE INVENTION

The present invention provides a continuous wave LIDAR system for use with a vehicle.

The invention in one form is directed to a vehicle including at least one LIDAR system coupled to the vehicle, the LIDAR system having an emitter, receivers and a controller. The emitter emits a Fourier series sum signal with each frequency given a substantially randomized phase. The receivers include a first receiver receiving a portion of the signal proximate to the LIDAR system; and a second receiver receiving a portion of a reflected signal, the reflected signal being a portion of the series sum signal after being reflected off of an object external to the vehicle. The controller is coupled to the emitter and the receivers. The controller being configured to de-convolve the portion of the reflected signal received by the second receiver with the portion of the series sum signal received by the first receiver, and to estimate a distance to the object dependent upon an identified time delay between the portion of the reflected signal and the portion of the series sum signal.

The invention in another form is directed to A LIDAR system for use with a vehicle. The LIDAR system has an emitter, receivers and a controller. The emitter emits a Fourier series sum signal with each frequency given a substantially randomized phase. The receivers include a first receiver receiving a portion of the signal proximate to the LIDAR system; and a second receiver receiving a portion of a reflected signal, the reflected signal being a portion of the series sum signal after being reflected off of an object external to the vehicle. The controller is coupled to the emitter and the receivers. The controller being configured to de-convolve the portion of the reflected signal received by the second receiver with the portion of the series sum signal received by the first receiver, and to estimate a distance to the object dependent upon an identified time delay between the portion of the reflected signal and the portion of the series sum signal.

An advantage of the present invention is that it uses low cost and low power telecommunications lasers in the signal emitter.

Another advantage is that the method of the invention precludes interference from another LIDAR system.

Yet another advantage of the present invention is that the data provides depth information relative to the detected object.

### BRIEF DESCRIPTION OF THE DRAWINGS

For a more complete understanding of the invention, reference is made to the following description and accompanying drawings, in which:

FIG. 1 is a diagram of a LIDAR or seismic sounding system 1 to probe medium 7 with reflectivity R(t), sending signal S(t) 4 and recording 6 return of R(t)\hat{x}S(t) 8. This setup records return V(t) with a primary detector 3 (black) and samples the output v(t) with a reference detector 2 (white), both mounted on a rotating gimbal 5 that can be used to exchange the positions of the two for calibration purposes;

FIG. 2(a) Series of pulse signals of Gaussian shape and separated by time interval Δt (see Sₚ(t) of Eqn. 2). (b) Swept chirp pulse from Eqn. 3 with linearly varying frequency and Gaussian amplitude envelope. (c) Example of medium profile R(t) with two distinct reflecting surfaces to be resolved. (d) Example of returned pulse signal from two reflection profile R(t), where the pulse width is narrow enough to accurately resolve amplitudes of the two reflectors. (e) Example of a returned swept chirp signal from two reflection profiles R(t), where no direct resolution of reflectors can be made. (f) Auto-correlation of the returned swept chirp signal with the known outputted waveform (Eqn. 3), allowing resolution of reflectors. Legends are: Pulses 9, Pulse width 10, Gaussian envelope 11, Chirp pulse 12, Reflections 13, Amplitudes 14, No resolution 15, In-accuracy 16, False reflections 17;

FIG. 3 illustrates Fourier domain analysis of LOCKIN imaging signal V(τ) from Eqn. 35. The different frequencies in the signal S_{cw}(t) are shown as spikes, each separated by gap Δω and the dashed arrowed illustration shows the operation of the LOCKIN technique which selects only the spikes and sets all noise in-between to a value of zero. Legends are: Noise 18, Dead zones 19;

FIG. 4(a) Left: Example clean LIDAR swept chirp signal S_{ch}(t) with frequency ranged from 0.2-1 MHz. Right: Frequency content of chirp signal S_{ch}(t) when extrinsic noise of SNR 1 is added. (b) Left: Example clean pulse signal Sₚ(t) with a peak power required to be 15-20 times that of a CW signal. Right: Frequency content of pulse signal Sₚ(t) when equivalent extrinsic CW noise is added. (c) Left: Example clean LOCKIN imaging LIDAR signal S_{cw}(t) with frequency ranged up to 1 MHz in Δω steps. Right: Frequency content of LOCKIN imaging LIDAR signal S_{cw}(t) when extrinsic noise of SNR 1 is added;

FIG. 5(a) Example auto-correlation function a(t) for chirp signal S_{ch}(t) from FIG. 2(b). (b) Raw result Zⱼ of LOCKIN imaging de-convolution, where a space clamp is used to identify the zero frequency component {Zⱼ} space of the reflective signal R(t). (c) Comparison of the perfect reflection profile R(t) with that derived using chirped, pulsed and LOCKIN imaging techniques. Legend: Space clamp 20, True Reflection R(t) 21, Chirp CW Method 22, Pulse Method 23, Zedika LOCKIN Method 24;

FIG. 6 Left: Examples of chirped, pulsed and LOCKIN soundings of a 375 m thick checkerboard medium by LIDAR. Sensor is moving at 7.5 km/s with an extrinsic SNR of 1. Right: The percent error in the retrieved profiles;

FIG. 7 illustrates another embodiment of the present invention relating to ground vehicles;

FIG. 8 is a flowchart provided to discuss an operative system;

FIG. 9 is presented to discuss the elements of the present invention;

FIG. 10A illustrates a signal from a first vehicle;

FIG. 10B illustrates a signal from a second vehicle;

FIG. 11 is a flowchart illustrating an embodiment of the present invention;

FIG. 12 illustrates an amplitude vs. frequency of a signal from the present invention;

FIG. 13A illustrates a LIDAR signal received by a first vehicle, that originated from the first vehicle;

FIG. 13B illustrates noise in the LIDAR signal of the first vehicle;

FIG. 13C illustrates a LIDAR signal generated by a second vehicle and received by the first vehicle:

FIG. 14 illustrates an ideal reflection and the experimental recovered reflected signal;

FIG. 15 illustrates, in a schematical form, what the present invention “sees” as a result of carrying out the method of the present invention relative to the first vehicle;

FIG. 16 illustrates, in a schematical form, what the present invention “sees” as a result of carrying out the method of the present invention relative to the second vehicle; and

FIG. 17 illustrates in a schematic form an embodiment of a LIDAR system of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE PREFERRED EMBODIMENTS

In the case of LIDAR, where a laser is being transmitted to the surface from high above Earth, there will be a signal return V(t) from many reflective targets R(t) throughout the depth of the atmosphere (i.e. Eqn. 1). For sound in the field of seismic sounding, it will be scattering from solid mediums of differing sonic impedance. This return signal V(t) will therefore be the time convolution of the wanted reflective distribution R(t) with the active signal S(t) transmitted into it (multiplied by instrument gain G):

$$\begin{matrix}V ( t ) = G \times R ( t ) ⊗ S ( t ) & ( 1 ) \\ {S}_{p} ( t ) = B {\sum }_{n = 1}^{N} {e}^{- {α ( t - n Δ t )}^{2}} & ( 2 ) \\ {S}_{ch} ( t ) = C {\sum }_{n = 1}^{N} {e}^{- {γ ( t - n Δ t )}^{2}} cos \{ [ {μ}_{n} t + {κ}_{n} ] \times t \} & ( 3 )\end{matrix}$$

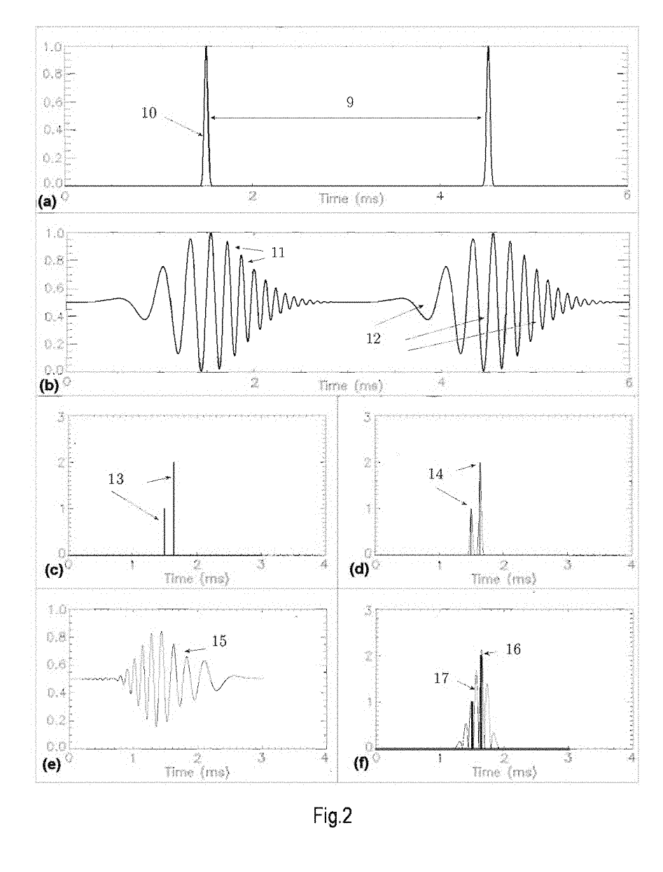

A direct way to sound the medium is to make the active signal S(t) a series of effective pulses as in Eqn. 2, each of very short time duration determined by constant α⁻². As the pulses are made shorter, they approach the form of a series of Dirac delta functions, which are separated by time duration Δt (see FIG. 2(a)). This will cause the return signal V(t) from Eqn. 1 to mirror the exact pattern of R(t) (i.e. the form of FIG. 2(d), closely matching the form of R(t) in FIG. 2(c), which shall also later repeat every Δt seconds). An optimal sounding signal could hence be a series of pulses separated by time Δt (where the interval choice would depend on the speed of the wave traveling in the medium of interest). However, practically creating such pulses is challenging in the field of engineering since it requires either the use of explosions for sound, or powerful pulse lasers for light (which in the case of space based platforms, also increases cost and limits the mission life). In the fields of oil exploration and Earth observation, technological and environmental factors make the use of pulsed sounding impractical.

A more achievable option is the use of a continuous wave (CW) system. For seismics this would allow a use of piezo-electric transducers and for LIDAR, utilization could be made of reliable and cheap semi-conductor laser modulators (as are used widely in the telecommunication industry). However, the disadvantage of such systems is the need to design an appropriate spread in CW signal modulation frequency content (e.g. for seismic imaging this is needed to ensure both high penetration and spatial resolution). Eqn. 3 gives such an example of a Chirp signal modulated within a Gaussian envelope. A standard CW technique to resolve different reflective targets in a medium is then to auto-correlate a return signal with a pre-stored complex conjugate example of that transmitted (as in Eqn. 4 below and see FIG. 2(e) for an example chirp return signal:

$$\begin{matrix}{χ}_{ch} ( t ) = V ( t ) ⊗ {S ( t )}^{*} & ( 4 ) \\ = G \times R ( t ) ⊗ a ( t ) & ( 5 ) \\ a ( t ) = {S}_{ch} ( t ) ⊗ {{S}_{ch} ( t )}^{*} & ( 6 )\end{matrix} \qquad$$

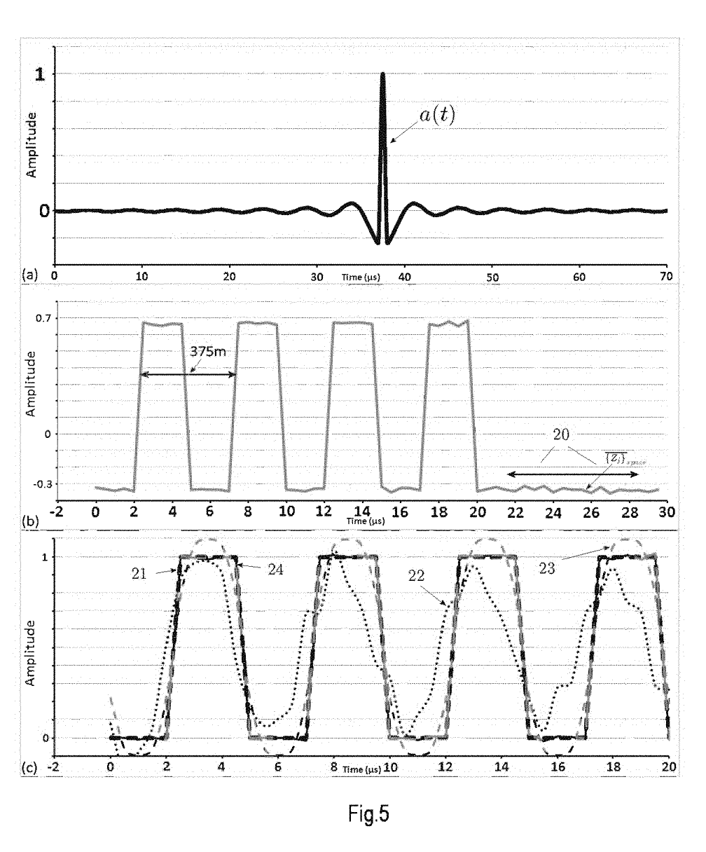

The relatively slowly varying modulation of chirp frequency then allows different reflectors to be resolved in the result χ_{ch}(t) due to the shape the signal auto-correlation function a(t) (calculated from Eqn. 6 and shown in FIG. 5(a)). The disadvantage of this is that the resolution and accuracy is limited by the form of this auto-correlation function and its side-lobes as shown in FIG. 5(a). Interference between the signals from different reflective targets close to each other can hence create false reflection indicators as shown in FIG. 2(f). In the case of LIDAR, the reflector amplitude measurement may need to be of around 1% accuracy, in order to determine atmospheric trace gas content. Chirp auto-correlation determination of reflector peak amplitudes may not therefore meet needed accuracy specifications.

A highly accurate way to determine the amplitude of a CW signal at a known frequency is to use a LOCKIN amplifier. In the case of a wanted signal of amplitude A at that frequency ωᵣ, the return result V(t) is simply multiplied with a computer generated sine and cosine wave also of frequency ωᵣ, then integrated over an integer number ‘q’ of oscillation periods:

$$\begin{matrix}{S}_{lc} ( t ) = A \times cos \{ {ω}_{r} t + φ \} & ( 7 ) \\ R ( t ) = R \times δ ( t - {t}_{r} ) & ( 8 ) \\ τ = t - dt & ( 9 ) \\ V ( τ ) = G \times A \times R \times cos \{ {ω}_{r} ( τ - {τ}_{r} ) + φ \} & ( 10 ) \\ \begin{matrix}Q = \frac{{ω}_{r}}{q π} \times {\int }_{0}^{2 π q / {ω}_{r}} V ( τ ) \times cos \{ {ω}_{r} τ \} d τ & ( 11 ) \\ = G \times A \times R \times cos \{ φ - {ω}_{r} {τ}_{r} \} & ( 12 )\end{matrix} & \\ \begin{matrix}I = \frac{{ω}_{r}}{q π} \times {\int }_{0}^{2 π q / {ω}_{r}} V ( τ ) \times sin \{ {ω}_{r} τ \} d τ & ( 13 ) \\ = - G \times A \times R \times sin \{ φ - {ω}_{r} {τ}_{r} \} & ( 14 )\end{matrix} & \\ \sqrt{{Q}_{2} + {I}^{2}} = G \times A \times R & ( 15 )\end{matrix}$$

Given knowledge of original amplitude A and receiving detector gain G, a LOCKIN integration over time can provide a highly accurate measure of reflectivity R using Eqns. 11 to 15 (where the signal V(t) is sampled after an interval of time dt beyond transmission, at adjusted time τ as in Eqn. 9). This is identical to the use of digital Fourier transforms if the number of samples M in the section of data analyzed is chosen to be an integer number m times the period of the chosen frequency (i.e. M=2πm/ωᵣ).

$$\begin{matrix}y ( ω ) = f t \{ y ( τ ) \} & ( 16 ) \\ {S}_{lc} ( ω ) = \frac{A}{2} [ δ ( ω - {ω}_{r} ) + δ ( ω + {ω}_{r} ) ] {e}^{i ( φ / {ω}_{r} ) ω} & ( 17 ) \\ R ( ω ) = {Re}^{- i {τ}_{r} ω} & ( 18 ) \\ V ( ω ) = \frac{G \times A \times R}{2} [ δ ( ω - {ω}_{r} ) + δ ( ω + {ω}_{r} ) ] {e}^{i ( φ / {ω}_{r} + {τ}_{r} ) ω} & ( 19 )\end{matrix}$$

In such a case the result of a LOCKIN amplifier can be duplicated by examination of the digital result V(ωᵣ) after a Fourier transform f t { } (as shown in Eqn. 16 for general function of adjusted time y(τ)). Then the reflector amplitude R is found simply as the absolute value of ∥2V (ωᵣ)/(G×A)∥ based on the digital result V(ωᵣ) from Eqn. 19 (where sample r=0.5Mωᵣ/ωₛ and ωₛ is the digital sampling frequency). However, targets such as the ground or atmosphere contain many reflective surfaces in practice, making the true reflection R(t) the result of Eqn. 20 (where P is the number of different reflectors):

$$\begin{matrix}R ( t ) = {\sum }_{j = 1}^{P} {R}_{j} \times δ ( t - {t}_{j} ) & ( 20 ) \\ \frac{2 V ( {ω}_{r} )}{G \times A} = {\sum }_{j = 1}^{P} {R}_{j} {e}^{i ( φ / {ω}_{r} - {τ}_{j} )} & ( 21 )\end{matrix}$$

Here the use of a standard LOCKIN technique gives a result that represents a sum from all P reflectors the wave has encountered, each with their unknown phase amplitude as a factor. This limits the use of standard LOCKIN amplifiers and CW signals in seismic imaging or LIDAR profiling.

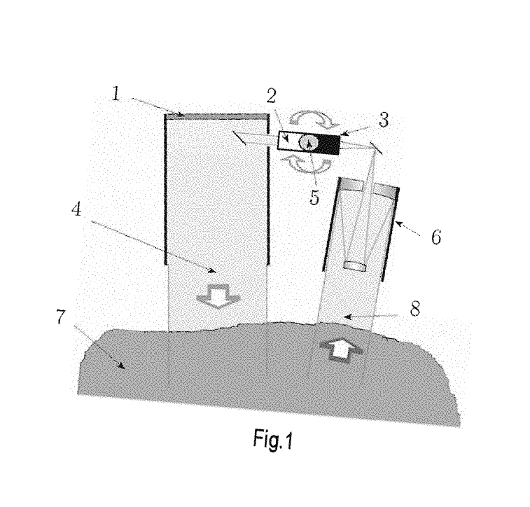

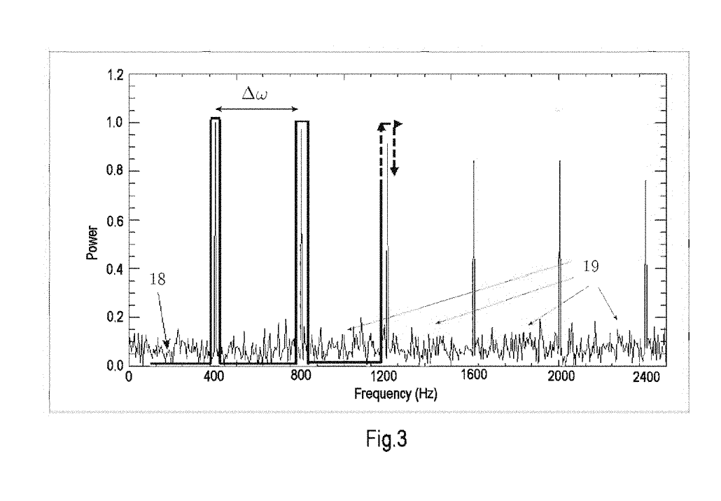

This section introduces methodology that shows how a number P of different reflectors within the profile R(t) can be resolved using specific frequency content design of the used CW signal. This output is made as a summation of P waves at separate frequencies ωₖ, each separated by a fixed difference Δω. This is required to resolve P different reflective surface in R(t) at a spatial resolution of c/π×ωₛ (where c is the speed of light or sound and the frequency spacing Δω=ωₛ/2×P). This signal 4 S_{cw}(t) (Eqn. 22) is transmitted towards the medium 7 to be probed as in FIG. 1. The mathematical values of φₖ in Eqn. 22 are randomly chosen to prevent large constructive or destructive interference. Again as in FIG. 1, next to the transmitter 1 is a receiving telescope 6 that focuses the return signal onto the primary detector 3 (shown in black and is also capable of rotating 5 to exchange places with the reference detector 2 in white). All received signals are sampled for a period T, designed specifically to sample an integer number ‘f’ of times the frequency interval (i.e. T=2πf/Δω and f is known as the oversampling factor). For calibration purposes and prior to beginning sounding measurements, the primary detector 3 (in black in FIG. 1 with its frequency dependent gain Gₖ) is held in the rotated position to view the raw transmission from the left and record the signal v(t)′ as in Eqn. 23. Calibration of this primary detector uses the Fourier transform of v(t)′, which is then sub-sampled in the frequency domain based on the chosen over sampling factor f (see Eqn. 25 and FIG. 3 which shows a graphical representation of this LOCKIN sub-sampling to select only chosen frequencies ωₖ and set all other data to zero as noise).

$$\begin{matrix}{S}_{c ω} ( t ) = {\sum }_{k = 1}^{P} {A}_{k} \times cos \{ {ω}_{k} t + {φ}_{k} \} & ( 22 ) \\ {v ( t )}^{′} = {\sum }_{k = 1}^{P} {G}_{k} \times {A}_{k} \times cos \{ {ω}_{k} t + {{φ}^{′}}_{k} \} & ( 23 ) \\ 2 {v ( ω )}^{′} = {\sum }_{k = 1}^{P} {G}_{k} \times {A}_{k} \times [ δ ( ω - {ω}_{k} ) + δ ( ω + {ω}_{k} ) ] {e}^{i ( {φ}_{k}^{′} / {ω}_{k} ) ω} & ( 24 ) \\ \begin{matrix}2 {v}_{k}^{′} = {v ( {ω}_{fk} )}^{′} & ( 25 ) \\ = {G}_{k} \times {A}_{k} {e}^{i {φ}_{k}^{′}} & ( 26 )\end{matrix} \\ & \\ v ( t ) = {\sum }_{k = 1}^{P} {g}_{k} \times {A}_{k} \times cos \{ {ω}_{k} t + {φ}_{k} \} \\ & ( 27 ) \\ 2 V ( ω ) = {\sum }_{k = 1}^{P} {g}_{k} \times {A}_{k} \times [ δ ( ω - {ω}_{k} ) + δ ( ω + {ω}_{k} ) ] {e}^{i ( {φ}_{k}^{′} / {ω}_{k} ) ω} & ( 28 ) \\ \begin{matrix}2 {v}_{k} = v ( {ω}_{fk} ) & ( 29 ) \\ = {g}_{k} \times {A}_{k} {e}^{i {φ}_{k}} & ( 30 )\end{matrix} \\ \begin{matrix}{ϒ}_{k} = ‖ \frac{{v}_{k}^{′}}{{v}_{k}} ‖ & ( 31 ) \\ = \frac{{G}_{k}}{{g}_{k}} & ( 32 )\end{matrix} & \end{matrix}$$

Once v′ₖ is recorded from the primary detector at frequencies ωₖ, the detector gimbal mount rotates to allow the reference detector 2 (FIG. 1 in white) to immediately sample the same output signal as v(t) (at new relative phases φₖ, offset from the φ′ₖ values seen in the primary detector calibration period). This completes the calibration of the instrumentation, allowing the sounding of the medium R(t) to begin. The same sub sampling then generates the result vₖ as in Eqn. 29. The magnitude Yₖ of Eqn. 31 hence gives the gain ratio between primary and reference detectors as in Eqn. 32.

$$\begin{matrix}R ( t ) = {\sum }_{j = 1}^{P} {R}_{j} \times δ ( t - {t}_{j} ) & ( 33 ) \\ τ = t - dt & ( 34 ) \\ V ( τ ) = {\sum }_{k = 1}^{P} {G}_{k} \times {A}_{k} {\sum }_{j = 1}^{P} {R}_{j} \times cos \{ {ω}_{k} ( τ - {τ}_{j} ) + {φ}_{k} \} & ( 35 ) \\ V ( ω ) = ft \{ V ( τ ) \} & ( 36 ) \\ \begin{matrix}{V}_{k} = V ( {ω}_{fk} ) & ( 37 ) \\ = {G}_{k} \times {A}_{k} e {φ}_{k} {\sum }_{j = 1}^{P} {R}_{j} {e}^{- i {ω}_{k} {τ}_{j}} & ( 38 )\end{matrix} & \\ & \\ {Z}_{j} = ft \{ \frac{{V}_{k} \times [ cos \{ {ω}_{k} {τ}_{g} \} + i \cdot sin \{ {ω}_{k} {τ}_{g} \} ]}{{ϒ}_{k} \times {v}_{k}} \} & ( 39 ) \\ {R}_{i} = {Z}_{i} - {( \overline{\{ {Z}_{j} \}} )}_{space} & ( 40 )\end{matrix}$$

Also now the sounding measurement V(τ) is made and transferred to the digital frequency domain to give the sub-sampled result Vₖ as in Eqn. 38. For convenience in the retrieved profile, it is beneficial to know the two-way travel time t_{g} from the transmitter to the ground (or seabed, hence giving τ_{g} from Eqn. 34). An estimate of the reflective profile shape Zⱼ is then found using Eqn. 39, which de-convolves the transmitted output signal from the return measurement. A LOCKIN method typically does not allow the use of zero frequency signals, so the result Zⱼ will incorrectly also have a mean value also of zero. In order to retrieve the zero Fourier component, an effective “space clamp” is required by averaging the result of Eqn. 39 in a region known to be devoid of reflectors (e.g. areas of insignificant atmospheric content just below the high flying or orbiting sensor). This gives the value of {Zⱼ}_{space}, as illustrated in FIG. 5(b), then the final result Rⱼ is obtained from Eqn. 40 after space clamp subtraction.

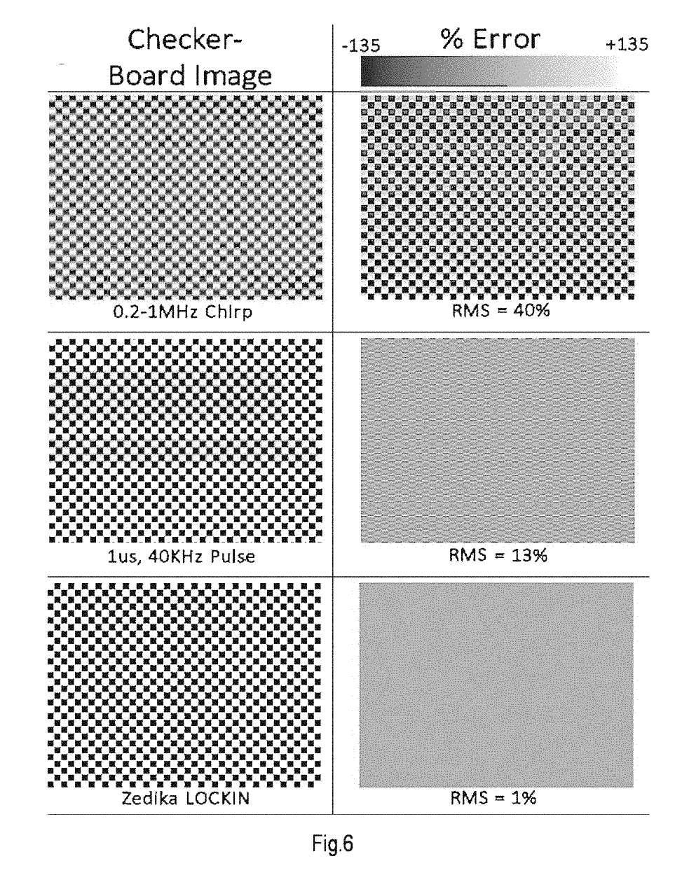

This final section shows simulations of results for atmospheric LIDAR sounding using chirp, pulse and LOCKIN imaging techniques and a signal to noise ratio set at around 1:1. The scenario is for a low Earth orbiting satellite at an altitude of 450 km moving at 7.5 km/s. LIDAR is used to image multilayered clouds of horizontal size 3.75 km and thickness 375 m. For purposes of resolution evaluation, the 2 dimensional cloud field is also made to take the form of a checkerboard (see FIG. 6). The LIDAR will be required to make ten atmospheric soundings per second, to resolve clouds at a horizontal resolution of 750 m. The sampling frequency ωₛ will be 2 MHz, with a need to resolve 2500 atmospheric reflectors (i.e. P=2500, Δω=400 Hz, f=40 and T=0.1 s).

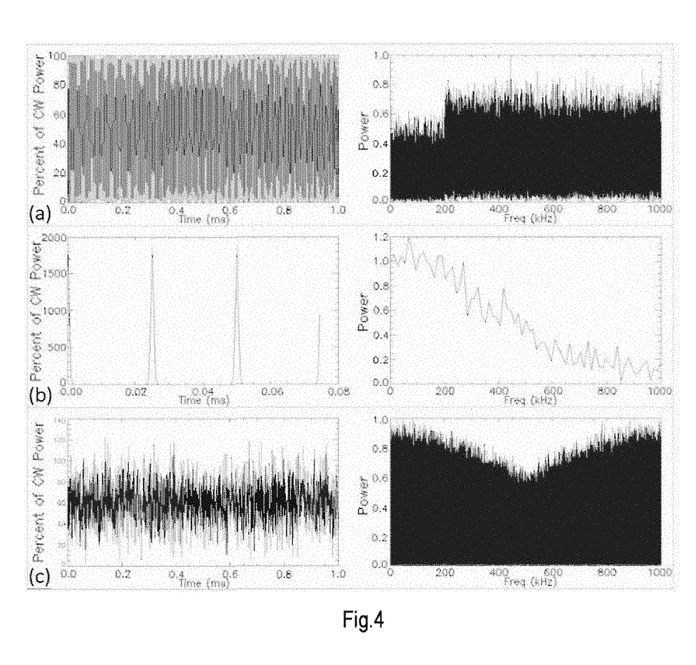

The chosen chirp signal S_{ch}(t) sweeps from 0.2-1 MHz every 0.1 seconds as shown in FIG. 4(a) with a random noise signal artificially added that is of a power magnitude equal to that generated by cosines (i.e. SNR=1, see noise amplitude on right of FIG. 4(a) and FIG. 5(a) for the corresponding auto-correlation function a(t) from Eqn. 6).

FIG. 4(b) shows the form of the chosen pulse laser, lasting for a duration of 1 μs and repeating at 40 kHz. Note that this requires 15-20 times the power used in the CW chirp laser above (hence the lower relative noise amplitude seen in the Fourier domain on right).

Finally FIG. 4(c) displays the combined 2500 frequencies used in the LOCKIN imaging signal. As with the chirp waveform, the power used here is over an order of magnitude less than that required for the pulse laser (again resulting in a SNR of 1:1 as shown in FIG. 4(c) right).

The thick black dashed curve in FIG. 5(c) shows an example of the ideal cross-section of the simulated checkerboard cloud field being probed on one 0.1 second sounding. FIG. 5(b) above displays the raw result Zⱼ from Eqn. 39 before the space clamp is applied. After subtraction of this offset, the retrieved LOCKIN R(t) profile is overlaid in solid grey over the perfect signal in FIG. 5(c). The dotted curve on the same graph shows the retrieval from the chirp autocorrelation and the dashed grey profile is that retrieved from the pulse laser.

With its greater power, the pulse retrieval is the cleanest signal compared to the other CW techniques. However, the finite pulse bandwidth leads to incorrect measurements of the cloud field amplitudes for such high spatial frequency targets positioned so close together. The chirp profile (in dots) also has significant inaccuracies in the retrieved amplitudes of the cloud field, in addition to greater noise. The LOCKIN imaging result does manage to recover the high spatial frequency structure of the checkerboard cloud field, albeit with greater noise than for the far more powerful pulse laser. FIG. 6 (left) shows two-dimensional images of these cloud field retrievals for the three different techniques, with maps of the associated errors displayed to the right. The top chirp image has significant random errors and biases, no doubt due to the effects of the auto-correlation side-lobes (FIG. 5(a)). The pulse laser cloud field (middle left) is of greater clarity than that for the chirp signal above but the errors on the right indicate substantial biases caused by the finite pulse bandwidth (leading to an overall RMS error of over 13%).

As expected from FIGS. 5(b) & (c), the LOCKIN imaging method results in the most clarity of the retrieved cloud fields and the lowest overall RMS error of around 1% (for a SNR of 1, see FIG. 6 (bottom)).

The presented LOCKIN imaging method has the potential to allow greater accuracy in sounding retrievals and hence a lower power requirement for seismic or LIDAR systems. In contrast to pulse or chirp techniques, the accuracy and resolution of the data here is defined by the bandwidth theorem and the choice of oversampling factor f. Hence in order to obtain better quality results, theory suggests that longer sampling intervals T and smaller frequency steps Δω need only be used (with the acknowledged penalty of longer periods needed for the sounding).

It should also be mentioned that for the field of seismics, extra factors may need consideration such as the greater attenuation of higher sound frequencies within water and the ground. This can be compensated for by carefully designed exponential high frequency amplification in the Fourier domain of result Vₖ from Eqn. 38. This process could be aided by the addition of extra tones within the transmitted signal (e.g. at intermediate sound frequencies at (ωₖ+ωₖ₊₁)/2, allowing iteration of the high frequency amplification curve to obtain consistent R(t) retrievals for both initially chosen and intermediate tones. Extra tones would also facilitate offline laser wavelengths for DIAL LIDAR sounding.

Finally it should be considered that practical generation of a signal modulated at frequencies ωₖ may involve a typical error dω, which will have impacts on the data accuracy. With the speed of current processors, this can be compensated for by use of simple factors e^{idω.t} to the sampled signals of V(τ) and v(τ) (i.e. to prevent creating an extremely low vₖ value for use in the denominator of Eqn. 39).

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

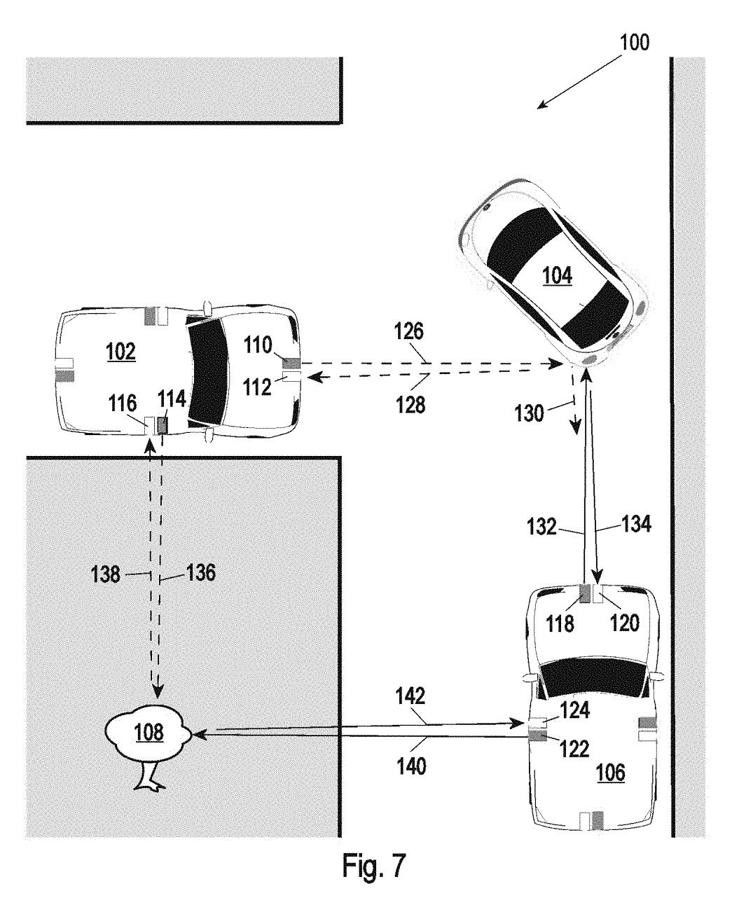

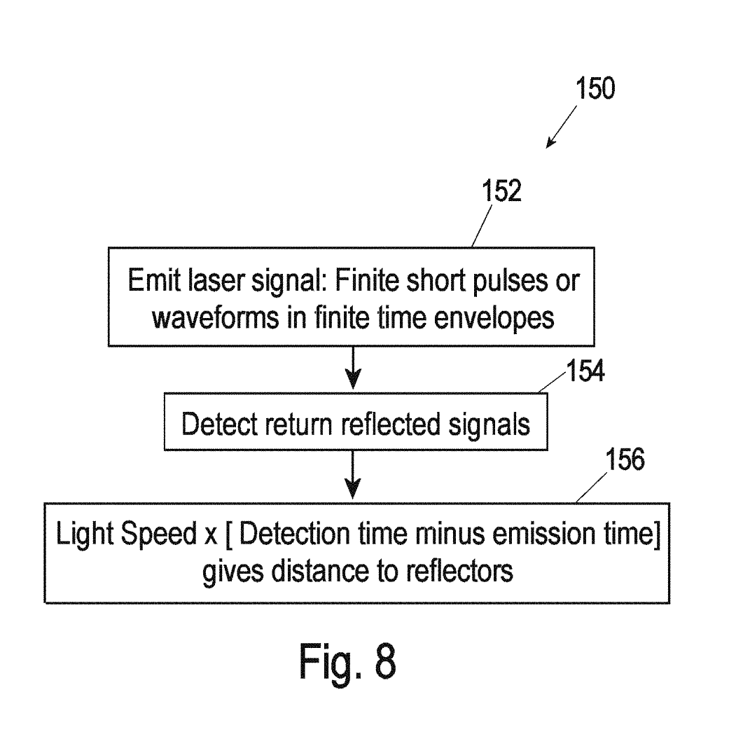

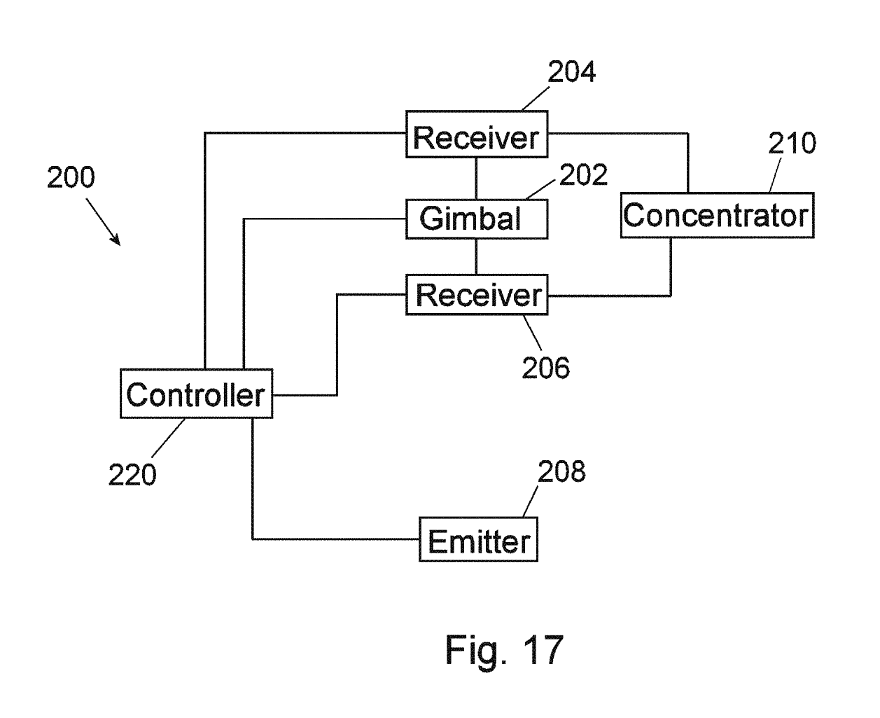

Now, additionally referring to FIGS. 7-17, a field of intense research is the development of autonomous vehicles that are able to drive or fly without the input of a human driver/pilot. This requires the highest quality methods of sounding the environment in which the vehicle travels, using photographic and active sensing systems. The emission of waves of light and/or sound into a medium has for years been used to give information on its content based on return reflections from boundaries of changing electromagnetic/acoustic impedance. There are several established ways of doing this, the first, as illustrated as method 150, is the use of repeated short duration pulses (step 152) whose detection upon return after reflection (step 154) allows determination of the distance from the source based on the time delay from emission vs reception (step 156). Another method is to use a multi-frequency waveform (such as a chirp), modulated by a repeating finite time envelope. Correlation of the return signal with the known time variation of the emitted waveform then identifies reflector locations, convolved with the auto-correlation function of the emitted signal form. A third technique like that of a chirp system uses a continuous wave laser with a pseudorandom binary sequence (PRBS) of ones and zeros and like the chirp technique to auto-correlate the known sequence with the return signal.

There are however significant limitations of these techniques, often regarding the expense of the needed laser/sound power and lack of accuracy/resolution that can result in undesired navigation errors. A short pulse system requires significant power output over the limited emission period while no energy is actually emitted during the dead zones between each pulse. In addition to the great power needed, such a pulse system is limited in its spatial resolution by the time of the pulse width. The continuous wave autocorrelation methodology of the present invention, takes advantage of more reliable, lower power, and lower cost solid-state lasers, such as those used in the telecommunication industry. However, accuracy and resolution of the retrieved reflection targets is limited by the shape of the auto-correlation function, with its side-lobes resulting in interference between closely spaced reflectors. Also in the event where such autonomous vehicles, with such a sounding system, becomes common-place, there is the danger of active sounding signals from one vehicle being received by another, which can result in undesirable consequences. The PRBS technique does not suffer these side lobe or interference problems, but it is susceptible to extrinsic noise and it is impossible to exactly generate the ones and zeros of the sequence using a continuous laser.

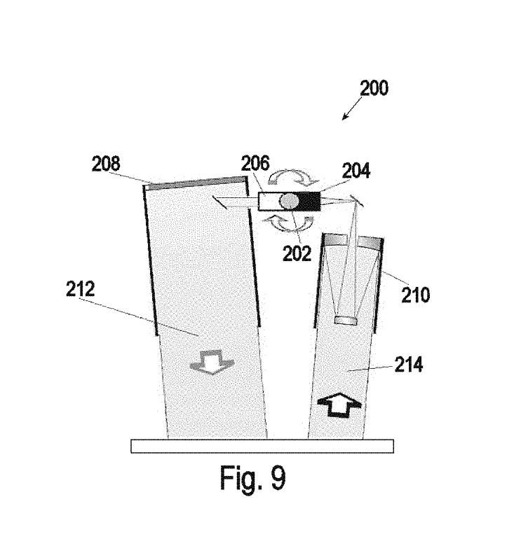

The present invention uses a specifically designed continuous waveform (CW), which can be generated by low cost and low power solid-state telecommunication lasers using auto-correlation techniques of an embodiment of the present invention. Such lasers operate at visible or infrared wavelengths that are chosen to be not situated on atmospheric absorption lines. The present invention includes a modified LIDAR system 200, as illustrated in FIG. 9, and discussed previously relative to FIG. 1. Here LIDAR system 200 includes a rotating gimbal 202, a first detector or receiver 204, a second detector or receiver 206, a signal emitter 208, and an antenna or optical concentrator such as a telescope 210. One of the detectors, illustrated here as receiver 204 receives a return signal 214 while receiver 206 samples the outgoing signal 212. A theoretically optimal waveform for sounding a medium would take the shape of an infinitely narrow Dirac Delta function (t), effectively being a pulse with a time duration of zero. Physically such a waveform cannot be generated by actual devices because it requires an infinite spread in transducer frequencies at the same phase, being an infinite sum of cosine functions all aligned with a phase of zero as in Eqn. 41.

$$\begin{matrix}δ ( t ) = {\sum }_{n = 1}^{∞} cos \{ nt \} & ( 41 ) \\ s ( t ) = {\sum }_{n = 1}^{∞} cos \{ nt + {φ}_{n} \} & ( 42 )\end{matrix}$$

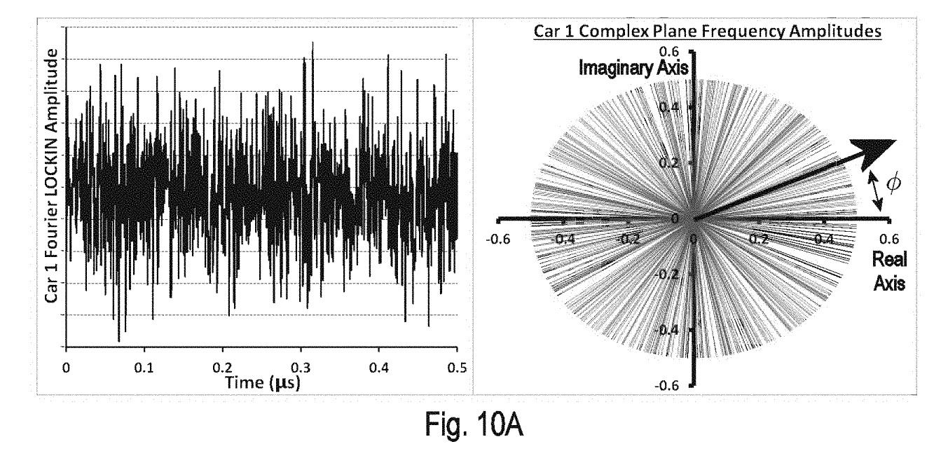

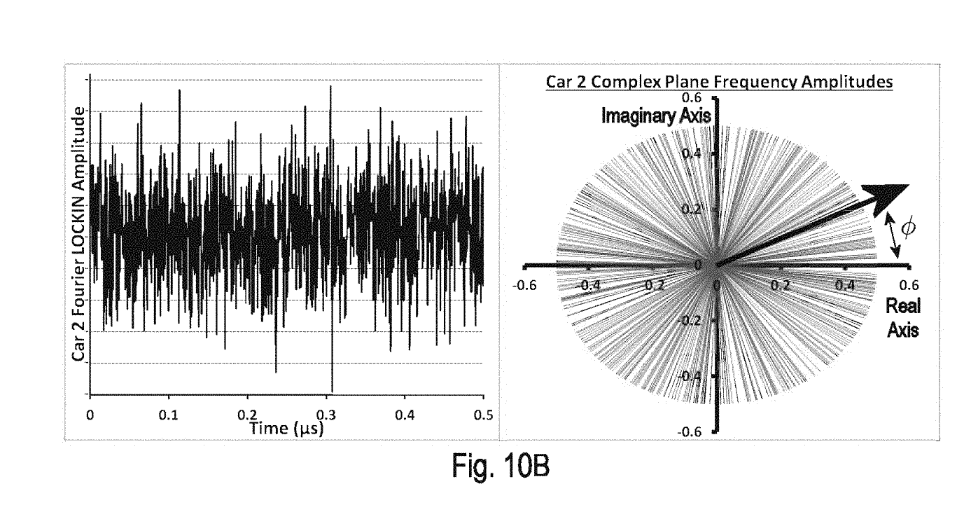

The present invention can be referred to as a Fourier LOCKIN that has the same advantages of a perfect Dirac Delta waveform, but can actually be generated by a physical laser/acoustic system 100, 200, as is given by Eqn. 42, where each frequency is generated with a random phase value of φₙ. Since this inventive technique makes use of the fast Fourier Transform on large digitally sampled data sets, it is optimal to choose a sampling size that is two raised to the power of an integer. For data collected, at a sampling frequency fₛ of 2 GHz, a sample size N of 2²² or 4,194,304 would allow 476.837 soundings per second. This represents no oversampling and hence an f value of 1, as in a worst case noise scenario, in line with the capabilities of a PRBS technique (i.e. because there are no FIG. 3 dead zones 19 of noise to set to zero). It follows that if a faster than 2 GHz sampling is chosen or a reduction is made to the retrieval rate from 476.837 Hz, both will increase the oversampling factor f and hence reduce noise in the Fourier domain at a percentage rate aligned with 100*(1−1/f)% (see FIG. 3). The waveform s(t) is most efficiently generated in the Fourier domain as S(ω), but such a process is most optimum when using an odd number of samples k chosen here as 2²²+1, to become Sₖ of Eqn. 41. This is after a random number generator is used to give N/2 random phase values φₖ with a mean of zero and a standard deviation of π (see FIGS. 10A and 10B).

$$\begin{matrix}{S}_{k} = \frac{1}{2} {\sum }_{{k}^{′} = 1}^{N / 2 - 1} {δ}_{k , {k}^{′}} [ cos \{ {φ}_{{k}^{′}} \} + i . sin \{ {φ}_{{k}^{′}} \} ] + \frac{1}{2} {\sum }_{{k}^{′} = N / 2}^{N} {δ}_{k , {k}^{′}} [ cos \{ {φ}_{{k}^{′}} \} + i . sin \{ {φ}_{{k}^{′}} \} ] & ( 43 ) \\ {S}_{k} = IFFT ( {S}_{k} ) & ( 44 )\end{matrix}$$

The time domain waveform sₖ is then recovered using an Inverse Fast Fourier Transform (IFFT) before the signal is truncated to remove the last sample and give the waveform an exact length of 2²² or N (it is recommended that the full 2²²+1 samples be emitted by the laser modulator 208 since it represents a repeating cycle, that is merely sampled in 2²² chunks for speed of the FFT). This will consist of N/2 or 2,097,152 distinct frequencies, ranging from 476.83716 Hz to 1×10⁹ Hz in 476.83716 Hz steps. Hence the amplitude |Sₖ| in the Fourier domain is undisguisable from that of a digitally sampled Kronecker delta function δₖ, which is the optimal of all sounding waveforms and hence highlights the advantages of this new technique. What is required for recovery of such a perfect waveform is knowledge of the over two million random phases φₖ, which comes from the reference detector 206 mentioned earlier and shown in FIG. 9.

The signal 214 returned to the LIDAR main receiver u(t) will be the convolution of the emitted signal s(t) and the wanted reflective distribution r(t). Then in the Fourier domain it follows that the main receiver voltage V₁(ω) will be the straight multiplication of both the frequency domain signal versions S(ω) and reflection profile R(ω), with the frequency dependent gain of the main receiver being G₁(ω):

u(t)=r(t) [symbol] s(t) (45)

V₁(ω)=G₁(ω)×[R(ω)×S(ω)] (46)

However, as in FIG. 9, the outgoing signal 212 u(t) will have been sampled by the reference detector 206, occurring at point to in the time frame to give signal u′(t) (where to represents the spatial position of the emitter with reference to and before the reflector surfaces the laser light is about to encounter in the road ahead after emission). The frequency domain reference detector signal V₂(ω) during normal operation is given by Eqn. 48, with G₂(ω) being the reference detector frequency dependent gain:

u′(t)=δ(t−t₀) [symbol] s(t) (47)

V₂(ω)=G₂(ω)×[e^{iωt}^{₀}×S(ω)] (48)

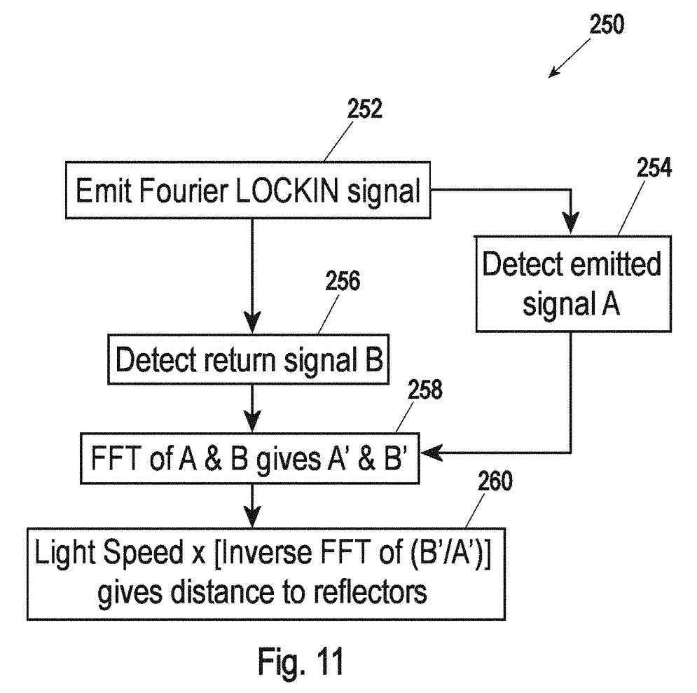

This process is described by the flow diagram of FIG. 11. It is anticipated that the main receiver and reference detector will not have identical spectrally dependent gains G₁(ω) and G₂(ω), but the ratio between these functions can easily be measured due to the rotational capability of gimbal 202 that orients detectors 204 and 206 between a main receiver position and a reference detector position. This uses Eqn. 49 and 50 calibration signals \tilde{Y}₁(ω) and \tilde{Y}2(ω) indicated with the tilde~, which are the frequency domain signals from detectors 204 and 206 synchronized in time and sampled consecutively of the same Eqn. 47 signal u′(t) (i.e. taken in sporadic calibration events to give ratio β(ω)=\tilde{Y}₁(ω)/\tilde{Y}2(ω) of Eqn. 51).

$$\begin{matrix}{{\tilde{ϒ}}_{1}}_{( ω )} = {G}_{1} ( ω ) \times [ {e}^{i ω {t}_{0}} \times S ( ω ) ] & ( 49 ) \\ {{\tilde{ϒ}}_{2}}_{( ω )} = {G}_{2} ( ω ) \times [ {e}^{i ω {t}_{0}} \times S ( ω ) ] & ( 50 ) \\ \begin{matrix}β ( ω ) = \frac{{{\tilde{ϒ}}_{2}}_{( ω )}}{{{\tilde{ϒ}}_{1}}_{( ω )}} & ( 51 ) \\ = \frac{{G}_{2} ( ω )}{{G}_{1} ( ω )} & ( 52 )\end{matrix} & \end{matrix}$$

It then follows that an accurate recovery of the exact wanted reflective distribution r(t) is found by controller 220 using Eqn. 53, which system 200 can perform more than 400 times per second and controller 220 using an inverse Fast Fourier transform:

$$r ( t ) = IFFT \{ β ( ω ) \times {e}^{i ω {t}_{0}} \times \frac{{V}_{1} ( ω )}{{V}_{2} ( ω )} \} \qquad ( 53 )$$

In use system 100, 200 experiences noise and imperfect frequency response, which has been simulated by the inventor using the Interactive Data Language (IDL) in a comprehensive recreation of an actual autonomous vehicle LIDAR environment of the present invention.

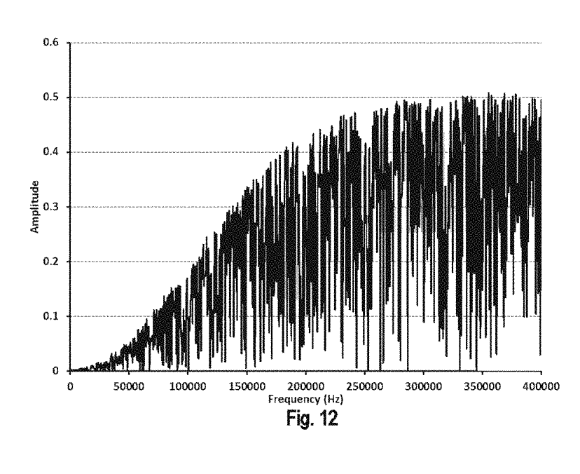

Controller 220 causes emitter 208 to generate the waveform s(t), in the Fourier domain. This is applied with IDL generating, for example, 2,097,152 random phases φₖ using a normal distribution. Such a waveform is depicted in FIG. 10A (left), demonstrating its resemblance to white noise. Emitter 208 can be implemented by a transducer such as a telecommunications EDFA. Considering that such an EDFA is incapable of generating frequencies below 50 KHz, system 200 uses a high pass envelope of the form shown by FIG. 12 which is used in the Fourier domain as the pre-mentioned functions G₁(ω) and G₂(ω), before the Eqn. 44 transformation to the time domain is performed.

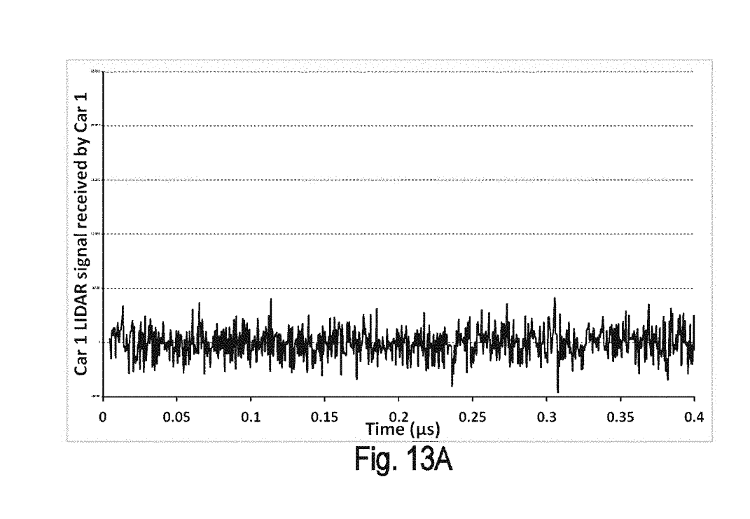

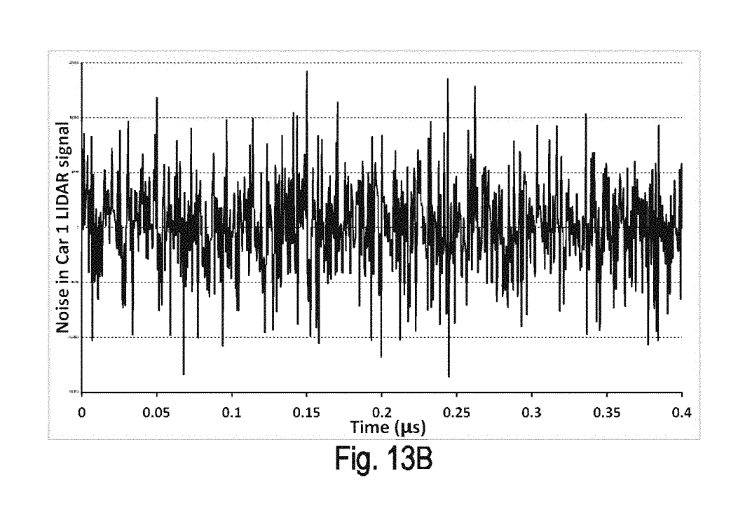

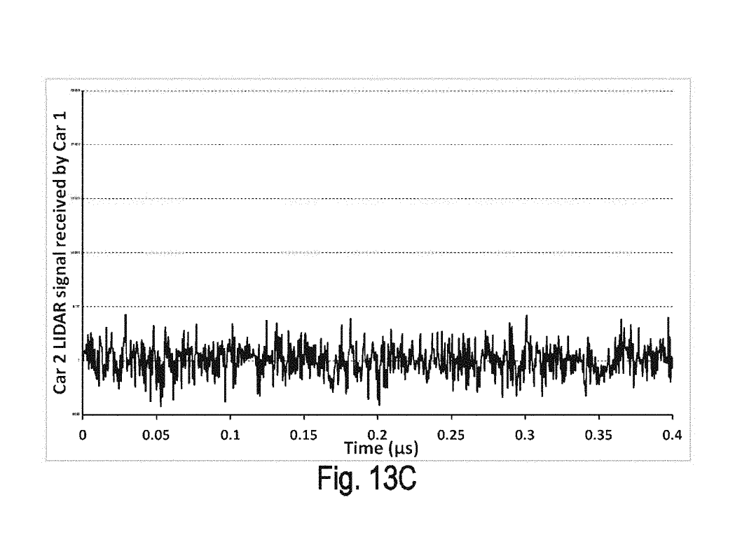

As shown in FIG. 7, with several systems 100 shown from two vantage points using two autonomous cars 102 and 106 (each with four systems 100, but not all separately identified), and another vehicle 104 (which may or may not be an autonomous vehicle, but is used for illustrative purposes), where cars 102 and 106 are capable of emitting and receiving LIDAR over 360° in, for example, one degree angular steps. It can be assumed that in such close range LIDAR sounding that attenuation of the LIDAR signal, as per the Beer-Lambert absorption law, is insignificant, as compared to the losses from reflection. It is also assumed, as a worst case scenario, that the reflection of the collimated LIDAR wave is then back-scattered in a Lambertian manner, meaning that the return signal diminishes with the inverse square of the distance from the car. Finally, it is assumed that the return signal, if due to a reflector within just 5 m, has a signal to noise ratio of just 0.25 (compare FIG. 13A—the received LIDAR signal with FIG. 13B the noise). Beyond this the value diminishes with the inverse square of the distance as just mentioned. The noise of FIG. 13B, for purposes of explanation, is added to the simulated signal V₁(ω) (FIG. 13A) as N(ω) (FIG. 13B), while an assumed signal to noise ratio of 1 is added to the reference detector signal V₂(ω) as N₀(ω) (for purposes of illustration, the noise signals are generated by IDL in the time domain using a normal distribution):

V₁(ω)=G₁(ω)×[R(ω)×S(ω)]+N(ω)+[e^{iωt}^{_{y}}×S′(ω)] (54)

V₂(ω)=G₂(ω)×[e^{iωt}^{₀}×S(ω)]+N₀(ω) (55)

To illustrate a realistic situation where multiple autonomated devices (as in FIG. 7) are at a particular scene a second waveform s′(t) emitted from a second car but with a different randomly generated frequency phase φ′(ω). This is added to the received Eqn. 54 assuming reflection from a target at time distance tᵣ (see FIG. 13C). The present invention, for purposes of illustration, has assigned to each autonomated vehicle 102, 106 a unique multi-million digit pin code, which distinguishes each vehicle from all other vehicles. For purposes of illustration, it is assumed that the environment depicted in FIG. 7 is sampled at 476.837 Hz in 1 degree spatial intervals, from LIDAR systems 100 situated in cars 102 and 106 at the FIG. 1 intersection. With an assumed sampling frequency of 2 GHz and the speed of light at 3×10⁸ m/s, this means the simulated retrievals have an outward going spatial resolution of 15 cm. Such resolution can easily be increased by simply changing the sampling frequency to greater than 2 GHz. For each angular slice the reflective profile r(t) is estimated by controller 220 based on 255 minus the 8 bit values from the BMP of FIG. 7 (ignoring road features and those of the car from which the light is emitted). A rapidly increasing optical depth is also assumed so the reflection profile essentially disappears after the first reflector encountered.

The two paths of car 102 and car 106 are converging on an intersection that car 104 occupies, in the scene visualized in FIG. 7. For ease of illustration cars 102 and 106 each have LIDAR systems of the present invention, that are oriented to cover a forward sector, a rearward sector, a left sector and a right sector, relative to each car. This is noted, for example, with car 102 having emitters 110 and 114, and receivers 112 and 116; and in a like manner car 106 has emitters 118 and 122, and receivers 120 and 124. Each pair of emitters/receivers is a system 200, and may be under the control of a single controller 220 in each car, so that the information coming from each sector can be combined and used as an integral system 200 for each car.

Emitter 110 is depicted as sending a signal 126 (one of the angularly spaced signals used for the purpose of illustration) that is shown reflecting off of car 104, producing signals 128 and 130. Emitter 118 sends a signal 132 that also reflects off of car 104 as signal 134. Receiver 120 receives signal 130 and 134. In a similar fashion emitter 114 sends a signal 136 from the right sector of car 102 that is reflected off of object 108 with signal 138 being returned to receiver 116. Object 108 is also detected by the left sector of car 106 when emitter 122 sends a signal 140 toward object 108 and a portion of a reflected signal, shown here as reflected signal 142, is received by receiver 124.

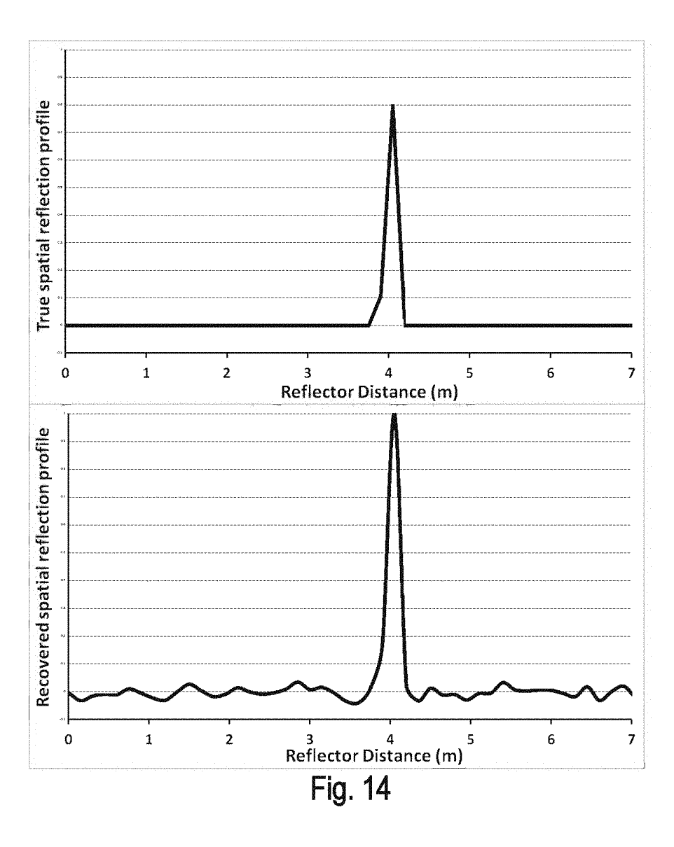

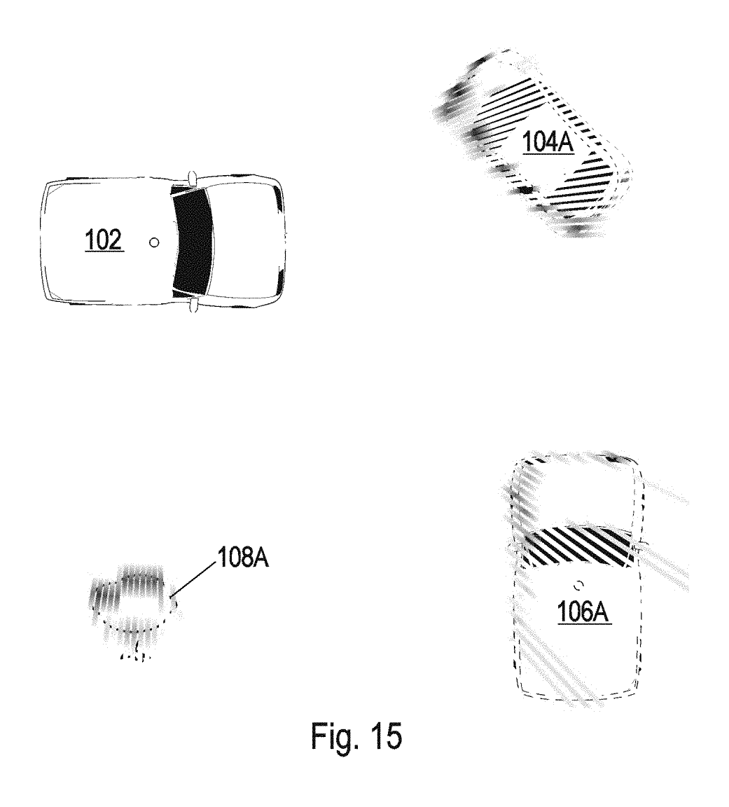

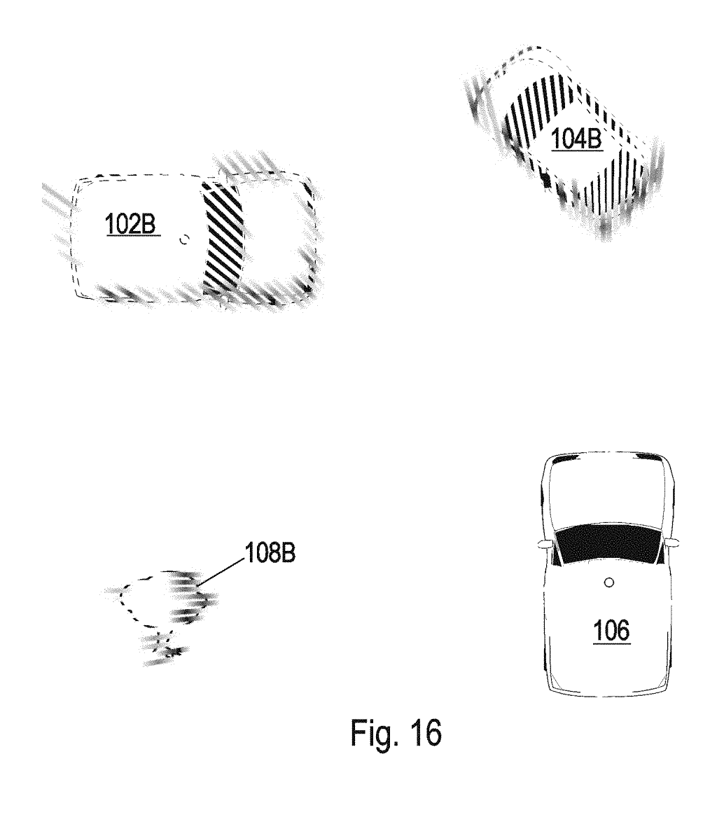

Cars 102 and 106 each have distinctly different effective encoding of the phase—that acts like a highly distinct fingerprint (see right sides of FIGS. 10A and 10B). A typical reflection profile from the slices through FIG. 7 is shown in the top chart of FIG. 14 with the profile retrieved shown in the bottom chart of FIG. 14, that illustrates the presence of noise but a clear solid retrieval of the reflection profile in the presence of the noise (FIG. 13B) which is illustrated as being four times the amplitude of the car 1 signal (FIG. 13A) and an equally large signal retrieved from car 2 (FIG. 13C). FIG. 15 then shows the results from controller 220 in car 102 in the scene defined by FIG. 7, which pictorially illustrates that the reflected signal in FIG. 14 (bottom) that the large noise signal is overcome by the present invention and that the LIDAR signal received from car 2 is almost completely ignored. FIG. 16 then shows the simultaneous results from the LIDAR system of car 106, again with the same noise rejection, but this time with the car 102 interference signal 130 now being ignored. FIG. 15 illustrates that images 104A, 106A and 108A, computed by controller 220, contains positional information that is then provided to other systems in vehicle 102 for navigation, operation and safety purposes so that vehicle 102 can be efficiently routed to a destination. In a similar manner FIG. 16 illustrates images 102B, 104B and 108B that are developed by the controller 220 in vehicle 106 for the same purposes already discussed.

This describes the newly developed Fourier LOCKIN LIDAR system 100, 200 and its application to greatly improve the field of autonomous LIDAR sounding systems. The use of continuous wave laser systems, long established for use in the telecommunications industry, rather than more expensive and power hungry pulse laser systems becomes possible due to the inventive aspects of the present inventions specific use of the Fourier LOCKIN waveform in the frequency domain. The waveform can be thought of as essentially a white noise signal, with known random phase values for each frequency used, recreates the Fourier domain amplitude structure of a perfect Dirac Delta function. Then knowledge of the phase values, by use of a reference detector, that samples the laser output allows recovery of the exact reflection profiles, rather than the same profile convolved with a laser pulse width or auto-correlation function (in the time domain). The Fourier LOCKIN system, of the present invention, is able to make over 400 soundings per second with a signal to noise ratio of 0.25 or lower. The system is effective even with multiple autonomous LIDAR systems that may be present on a scene, whose laser signals are exchanged to other vehicles as interference. However, the presence of millions of equally spaced frequencies with a random phase fingerprint—allows each separate vehicle to ignore the signals from over vehicles as random noise, removing the problem of interference or cross talk between different vehicles that use prior art pulse or auto-correlation laser systems.

From a similar perspective the present invention includes a vehicle 102 having a chassis and at least one LIDAR system 100 (collectively 110 and 112 as one system 100 and 114 and 116 as another system 100) coupled to the chassis. The LIDAR system includes an emitter 110, 208 emitting a Fourier series sum signal with each frequency given a substantially randomized phase. There are a plurality of receivers 112 (which includes receivers 204 and 206) including a first receiver 204 and a second receiver 206, the first receiver 204 receiving a portion of the Fourier series sum signal 126 proximate to the LIDAR system 100, the second receiver 206 receiving a portion of a reflected signal 128, the reflected signal 128 being a portion of the Fourier series sum signal 126 after being reflected off of an object 104 external to the vehicle 102. There is a controller 220 that is coupled to the emitter 208, the first receiver 204 and the second receiver 206, the controller 220 is configured to de-convolve the portion of the reflected signal 128 received by the second receiver 206 with the portion of the Fourier series sum signal received by the first receiver 204, and to estimate a distance to the object 104 dependent upon an identified time delay between the portion of the reflected signal 128 and the portion of the series sum signal 126.

The present invention has at least four areas in which the system 100, 200 is novel in comparison to prior art devices.

1. Today only two sounding techniques are generally used, those being either a pulse ranging system or a correlation of a known waveform system such as a chirp signal. The Fourier LOCKIN system is distinct from both these in the way the random phase fingerprint allows the use of multiple systems without interference.

2. The Fourier LOCKIN technique of the present invention can operate with a signal to noise ratio (S/N) lower than 0.25, compared to values of around 1 for existing LIDAR systems. Also a constant background signal at zero Hz frequency is entirely ignored. This means a low cost laser with only a fraction of the power of other systems will give the same accuracy. This present invention also has the advantage over prior art systems in that in operating during events such as snow storms its rejection of noise signals.

3. As autonomous vehicle LIDAR becomes more common on both cars and drones there exists the challenge of interference, with prior art systems, from one vehicle to another. Even though it is possible to limit such interference with collimated optics, the dangers involved in even a rare occurrence are severe. The Fourier LOCKIN system, of the present invention, uses a signal containing 5 million frequencies each with a randomly generated phase. This results in any particular LIDAR receiver entirely ignoring any other LIDAR signal without those phases (i.e. as random noise), making it effectively a 5 million digit pin number unique to each car and resulting in interference being an effective impossibility.

4. Resolution or accuracy of ranging using prior art pulse/correlation systems are dependent on the pulse width or the auto-correlation function. In the Fourier LOCKIN system 100, 200 of the present invention the resolution/accuracy is improved and limited only by the sampling frequency. This means it has the potential to benefit the users of this form of LIDAR for vehicular navigation/safety and for seismic imaging etc. with low cost highly accurate systems with improved noise rejection.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle, comprising:
a chassis; and
at least one LIDAR system coupled to the chassis, the LIDAR system including:
an emitter emitting a Fourier series sum signal with each frequency given a substantially randomized phase;
a plurality of receivers including a first receiver and a second receiver, the first receiver receiving a portion of the Fourier series sum signal proximate to the LIDAR system, the second receiver receiving a portion of a reflected signal, the reflected signal being a portion of the Fourier series sum signal after being reflected off of an object external to the vehicle; and
a controller coupled to the emitter, the first receiver and the second receiver, the controller being configured to de-convolve the portion of the reflected signal received by the second receiver with the portion of the Fourier series sum signal received by the first receiver, and to estimate a distance to the object dependent upon an identified time delay between the portion of the reflected signal and the portion of the series sum signal.

2. The vehicle of claim 1, wherein the controller uses a Fast Fourier Transform (FFT) algorithm to de-convolve the portion of the reflected signal with the portion of the series sum signal.

3. The vehicle of claim 1, wherein the LIDAR system further includes a rotatable gimbal coupled to the first receiver and the second receiver, the controller being coupled to the rotatable gimbal, the controller being configured to cause the first receiver and the second receiver to be reversed in position by commanding the rotatable gimbal to rotatably move the first receiver and the second receiver.

4. The vehicle of claim 3, wherein the controller is further configured to calibrate the first receiver and the second receiver after a changing of positions of the receivers.

5. The vehicle of claim 1, wherein the controller is configured to cause the emitter to emit a plurality of Fourier series sum signals in distinct angular displacements relative to the system.

6. The vehicle of claim 5, wherein the distinct angular displacements are in one degree increments.

7. The vehicle of claim 1, wherein the at least one LIDAR system is a plurality of LIDAR systems including a forward directed LIDAR system and a rearward directed LIDAR system.

8. The vehicle of claim 1, wherein the LIDAR system is configured to estimate the distance when the signal to noise ratio of the reflected signal is below 1.

9. The vehicle of claim 8, wherein the LIDAR system is configured to estimate the distance when the signal to noise ratio of the reflected signal is below 0.25.

10. The vehicle of claim 1, wherein the LIDAR system is configured to ignore a randomized phase signal from another LIDAR system.

11. The vehicle of claim 1, wherein the emitter emits a continuous waveform.

12. The vehicle of claim 11, wherein the emitter includes a low power solid-state telecommunication laser that generates the continuous waveform.

13. A LIDAR system for use with a vehicle, the LIDAR system comprising:
an emitter emitting a Fourier series sum signal with each frequency given a substantially randomized phase;
a plurality of receivers including a first receiver and a second receiver, the first receiver receiving a portion of the series sum signal proximate to the LIDAR system, the second receiver receiving a portion of a reflected signal, the reflected signal being a portion of the series sum signal after being reflected off of an object external apart from the vehicle; and
a controller coupled to the emitter, the first receiver and the second receiver, the controller being configured to de-convolve the portion of the reflected signal received by the second receiver with the portion of the series sum signal received by the first receiver, and to estimate a distance to the object dependent upon an identified time delay between the portion of the reflected signal and the portion of the series sum signal.

14. The LIDAR system of claim 13, wherein the controller uses a Fast Fourier Transform (FFT) algorithm to de-convolve the portion of the reflected signal with the portion of the series sum signal.

15. The LIDAR system of claim 13, wherein the LIDAR system further includes a rotatable gimbal coupled to the first receiver and the second receiver, the controller being coupled to the rotatable gimbal, the controller being configured to cause the first receiver and the second receiver to be reversed in position by commanding the rotatable gimbal to rotatably move the first receiver and the second receiver.

16. The LIDAR system of claim 15, wherein the controller is further configured to calibrate the first receiver and the second receiver after a changing of positions of the receivers.

17. The LIDAR system of claim 13, wherein the controller is configured to cause the emitter to emit a plurality of series sum signals in distinct angular displacements relative to the system.

18. The LIDAR system of claim 13, wherein the LIDAR system is configured to estimate the distance when the signal to noise ratio of the reflected signal is below 1.

19. The LIDAR system of claim 18, wherein the LIDAR system is configured to estimate the distance when the signal to noise ratio of the reflected signal is below 0.25.

20. The LIDAR system of claim 13, wherein the emitter includes a low power solid-state telecommunication laser that generates a continuous waveform.
